(19) United States
(12) Patent Application Publication
(10) Pub. No.: US 2011/0238758 A1
(43) Pub. Date: Sep. 29, 2011

(54) Method And Apparatus For Displaying Feeds Content Of Contact And Processing Apparatus And System Thereof

(75) Inventors: Zhu Liang, Shenzhen City (CN); Xing Yao, Shenzhen City (CN); Songtao Lin, Shenzhen City (CN); Zhihao Zheng, Shenzhen City (CN); Jiang Jiang, Shenzhen City (CN); Qun Yu, Shenzhen City (CN); Yue Wu, Shenzhen City (CN); Zhenyu Guo, Shenzhen City (CN); Xiaojun Zeng, Shenzhen City (CN); Min Chen, Shenzhen City (CN); Yanjie He, Shenzhen City (CN); Shan Chen, Shenzhen City (CN); Wenjiang Zhou, Shenzhen City (CN); Hao Wu, Shenzhen City (CN); Ye Deng, Shenzhen City (CN)

(73) Assignee: TENCENT TECHNOLOGY (SHENZHEN) COMPANY LIMITED, Shenzhen City (CN)

(21) Appl. No.: 13/153,791

(22) Filed: Jun. 6, 2011

Related U.S. Application Data
(63) Continuation of application No. PCT/CN2009/074906, filed on Nov. 17, 2009.

(30) Foreign Application Priority Data
Dec. 5, 2008 (CN) 200810239260.9

(51) Int. Cl. G06F 15/16

(52) U.S. Cl. 709/204

(57) ABSTRACT

A system for displaying feeds contents of a contact and for processing feeds contents of a contact. The system obtains feeds content data of a contact of a user, mixes and sorts the feeds content data. The system pulls out, when the user requests for obtaining the feeds contents of the contact, complete information of the feeds contents requested by the user, and displaying the complete information.

### CROSS-REFERENCE TO RELATED APPLICATIONS

This application is a continuation of International Application No. PCT/CN2009/074906, filed Nov. 17, 2009. This application claims the benefit and priority of Chinese Patent Application No. 200810239260.9, filed Dec. 5, 2008. The entire disclosures of each of the above applications are incorporated herein by reference.

### FIELD

The present disclosure relates to an Internet communication technology field, and displaying feeds content of contacts, and processing feeds content of contacts.

### BACKGROUND

This section provides background information related to the present disclosure which is not necessarily prior art.

With the rapid development of Internet, the coming of web 2.0 provides a favorable market development environment for individual orientated services, such as a blog. There are tens of millions of users who use blog products daily, which has generated very important commercial value. A Social Networking Service (SNS) is considered an important and effective fundamental platform for the blog, and makes a big contribution to total values of blog and attracts users.

At present, in an investigation and analysis performed on users who visit blogs, the accesses to dynamic information of contacts, e.g. a newly published log and a newly uploaded photo, by the users account for a vast majority of all accesses of the users. However, when a user wants to obtain complete contents of new dynamic information of a contact, the user can not choose but access to a site where the dynamic information is published to obtain the dynamic information. In the blog, dynamic information of a contact is displayed to blog users mainly through a brief prompt of an information center (as shown in FIG. 1). The information center shows the user the latest dynamic information of the contact with a brief prompt manner. If the user wants to know more details of the latest dynamic information of the contact, he/she can't directly browse the details on the prompt page of the information center but access to a zone of the contact, which results in too many operations and reduces the users' experience to a great extent.

The dynamic information of contacts concerned by a user can be well subscribed by the user through a Really Simple Syndication (RSS) system, and details of subscribed dynamic information of contacts can be conveniently browsed by the user in time. However, the system needs the user to add concerns to contacts one by one, and the process for forming a concern chain is very fussy. With the popularization of the network, a user owns a large amount of contacts, and the process for subscribing dynamic information of contacts is performed based on a non-SNS chain, which is too mechanized. Besides, the subscribed contact information is relatively independent, so dynamic information of all contacts can't be experienced and processed as a whole.

### SUMMARY

This section provides a general summary of the disclosure, and is not a comprehensive disclosure of its full scope or all of its features.

A method and apparatus for displaying feeds contents of a contact, and an apparatus and system for processing feeds contents of a contact, which can display complete contents of dynamic information updated by contacts of the user on the user terminal or the client.

The method for displaying feeds contents of a contact includes obtaining feeds content data of a contact of a user, and mixing and sorting the feeds content data which comprises complete information of feeds contents. The method further includes pulling out, when the user requests for obtaining the feeds contents of the contact, complete information of the feeds contents requested by the user, and displaying the complete information.

The apparatus for displaying feeds contents of a contact includes a display content pulling unit that pulls complete information of feeds contents corresponding to a request and obtains the feeds contents of a contact sent by a user from feeds content data obtained by being mixed and sorted of the contact. A data displaying unit displays the complete information of the feeds contents corresponding to the request of the user and pulled out by the display content pulling unit.

The apparatus for processing feeds contents of a contact includes a single contact data pulling module to obtain feeds content data of a contact of a user. A contact data mixing and sorting processing module mixes and sorts the feeds content data obtained by the single contact data pulling module. A contact data aggregation module aggregates the feeds content data obtained by being mixed and sorted by the contact data mixing and sorting processing module.

The system for processing feeds content of contacts includes an apparatus for displaying feeds contents of a contact and pulls complete information of feeds contents corresponding to a request sent by a user for obtaining the feeds contents of a contact from mixed and sorted data and for displaying the complete information. An apparatus for processing feeds contents of a contact to obtain feeds content data of a contact of a user, mix and sort the feeds content data, and aggregate the mixed and sorted data.

In various embodiments the following benefits may be realized.

Compared with the conventional method, various systems described herein address when a user wants to obtain detailed contents of latest dynamic information of a contact, the user has to access a site on which the dynamic information is generated to obtain the dynamic information. The detailed contents of latest dynamic information of the contact may be directly displayed to the user through web pages of the user terminal, which enhances users' experiences.

Various embodiments perform aggregation and display on the SNS relationship chain based dynamic information data of a contact. When a user obtains complete contents of dynamic information data of the contact, the dynamic information of group contacts of a web side or an IM side is aggregated on basis of the SNS chain, and is displayed according to a certain sorting regulation, such as according to publication time of blogs.

The user cares for different contacts to different degrees, and the technical solutions of the present invention provide the user with the ability for setting information for contacts whose dynamic information needed to be displayed, and the number of contacts whose information may be displayed is determined by the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a screenshot of an information center in the prior art;

FIG. 2 is a brief flowchart illustrating a SNS relationship chain based method for aggregating feeds contents of contacts in accordance with an embodiment of the present invention;

FIG. 3 is a schematic diagram illustrating an apparatus for displaying feeds contents of contacts in accordance with an embodiment of the present invention;

FIG. 4 is a schematic diagram illustrating an apparatus for processing feeds contents of contacts in accordance with an embodiment of the present invention;

FIG. 5 is a schematic diagram illustrating a SNS relationship chain based system for aggregating feeds contents of contacts in accordance with an embodiment of the present invention; and

FIG. 6 is a schematic diagram illustrating an application instance of the system in accordance with the embodiment of the present invention.

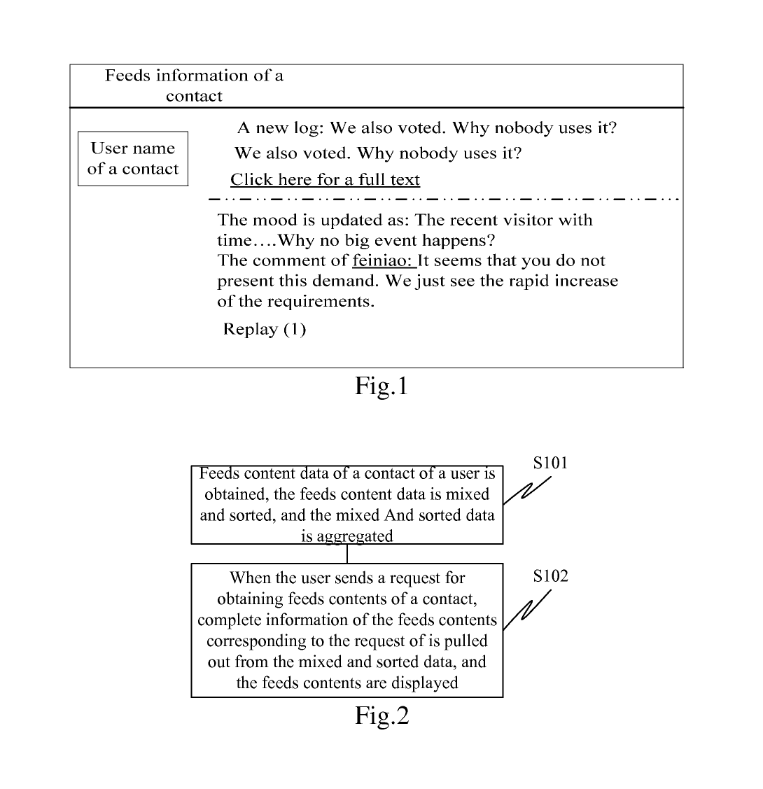

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Various embodiments provide a SNS relationship chain based method and system for aggregating feeds contents of contacts which can address the situation that in the conventional Social Networking community system, when a user wants to obtain complete contents of dynamic information of a contact, e.g. complete contents of a network log or an online album in the blog of a contact, the user has to access a place where the dynamic information is generated to obtain the dynamic information. The method and apparatus directly display complete contents of dynamic information of contacts, which enhances users' experiences. The corresponding display may be performed in a web mode or on a software client.

The various embodiments address the situation that in the conventional Social Networking community system, the name of a contact is taken as a display symbol of feeds contents of the contact. The dynamic information of the contact can be aggregated and displayed based on publication time of the dynamic information, which clearly and directly enhances users' experiences; and may provide the user with a function of setting contacts. The user decides the contacts whose information may be displayed, with which the system has more powerful functions.

As shown in FIG. 2, a SNS relationship chain based method for aggregating feeds contents of contacts includes the following processes.

Block S101: Feeds content data of a contact of a user is obtained, the feeds content data is mixed and sorted, and mixed and sorted data is aggregated.

Block S102: When the user sends a request for obtaining feeds contents of the contact, complete information of feeds contents corresponding to the request of the user is pulled out from the mixed and sorted data, and then is displayed.

Specifically, there are two methods for obtaining the feeds content data of the contact of the user in block S101.

In various embodiments, feeds content data of the contact is obtained according to the contact information in SNS relationship chain set by the user, and the specific processes are as follows:

When the contact information in the SNS relationship chain changes, e.g. if a new piece of contact information is added, obtained feeds content data corresponding to the added contact information is added to previously obtained the feeds content data. If the contact information is deleted, feeds content data corresponding to the contact is deleted from the previously obtained feeds content data.

Both the user terminal and the system can modify the contact information, and mainly add the contact information to the previously obtained contact information or deleting the contact information from previously obtained contact information.

If the contact information in the SNS relationship chain does not change, the feeds content data of the contact is obtained according to the stored contact information.

In other various embodiments, the feeds content data of the contact of the user is obtained through another method.

When the feeds content data of the contact of the user is updated, the feeds content data of the contact is obtained through a received update notification message. The update notification message includes the contact information of the contact whose data is updated and a timestamp of the update time. The specific processes include the following processes.

Every time the feeds content data of a contact is obtained, the latest update time of the data is stored as a timestamp of this update. When the update notification message is received, the stored timestamp is compared with the timestamp of the update time. If the timestamp of the update time is closer to the current time than the stored timestamp, the updated data corresponding to the timestamp of the update time is read out, and the latest timestamp in the timestamps of the update times is stored as the timestamp of this update.

For example, the contact A of the user updates logs in a blog at “a” time, and a username or IP address of the contact A and the timestamp “a” of the time that the log is updated may be included in the update notification message, and thus the log data updated by the contact A may be obtained.

Specifically, detailed processes of block S101 may further include: aggregating the mixed and sorted data and storing the aggregated data as the aggregated mixed and sorted data. When feeds content data of all contacts of the user is updated, the latest updated data is obtained, and the obtained latest updated data is directly added to the stored aggregated mixed and sorted data. Thus, the time for performing mixing, sorting and aggregation may be saved.

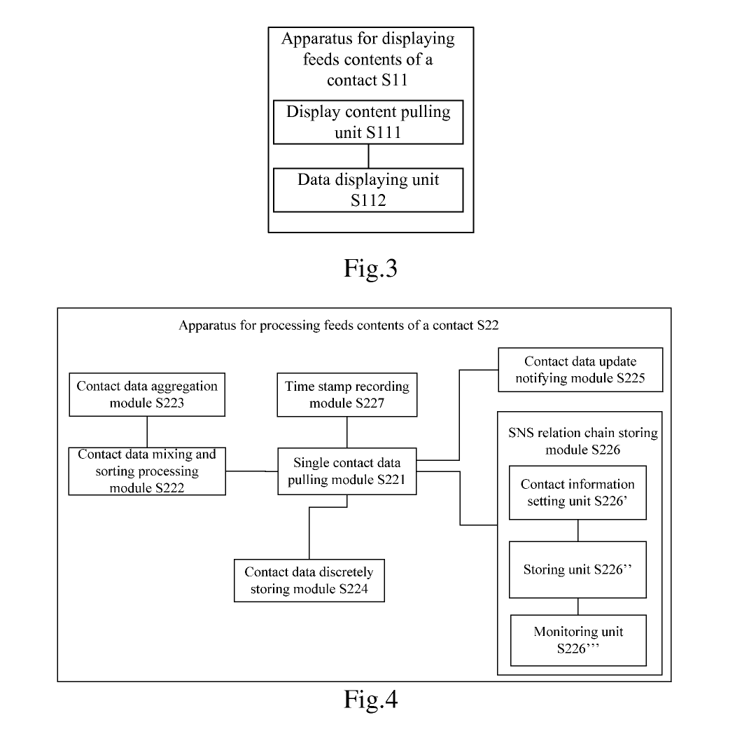

As shown in FIG. 3, an apparatus S11 for displaying feeds contents of contacts includes the following units.

A display content pulling unit S111 is configured to, when a user sends a request for obtaining feeds contents of a contact, such as a network log or an online album in the blog of the contact, pull complete information of feeds contents corresponding to the request of the user from data obtained by mixing, sorting and aggregating the obtained feeds content data of the contact.

A data displaying unit S112 is configured to display the complete information of the feeds contents which correspond to the request of the user and are pulled out by the display content pulling unit S111.

The data obtained by mixing, sorting and aggregating all the feeds contents of the contacts obtained by the user includes: abstracts of the feeds contents of the contact of the user (e.g., content abstracts of a log published in blog by the contact of the user), and complete information of the feeds contents corresponding to the abstracts (e.g., all contents of the abstract of the log).

The data displaying unit S112 may display the mixed, sorted and aggregated data in an abstract list to the user. If the contents to be obtained are selected from the abstract list, the detailed contents corresponding to the abstract may be directly obtained. Compared with that the detailed contents can not be directly displayed on the user terminal in the conventional method, the present invention can enhance users' experiences.

As shown in FIG. 4, an apparatus S22 for processing feeds contents of contacts includes the following modules.

A single contact data pulling module S221 is configured to obtain feeds content data of a contact of a user.

A contact data mixing and sorting processing module S222 is configured to mix and sort the feeds content data obtained by the single contact data pulling module S221.

A contact data aggregation module S223 is configured to aggregate the data processed by the contact data mixing and sorting processing module S222.

The apparatus S22 may further include a contact data discretely storing module S224, configured to store feeds content data of all contacts (such as feeds content data of all contacts who use the QQ software) and timestamps corresponding to the feeds content data. For example, the contact A of the user updates his/her logs at a time point, and the time at which he/she updates the logs is taken as a timestamp that he/she updates the feeds content data. The contact data discretely storing module S224 is further configured to provide a data source when the single contact data pulling module S221 obtains feeds content data of all contacts.

The apparatus S22 may further include a contact data update notification module S225, configured to monitor all feeds content data of the contact every time the feeds content data of the contact is obtained, and send an update notification message to the single contact data pulling module S221 when the feeds content data is updated.

The single contact data pulling module S221 updates the obtained feeds content data according to the update notification message sent from the content data update notifying module S225.

For instance, it is supposed that the contact A and contact B in twenty contacts of the user update logs, and then the update notification message may carry the user names of the contact A and contact B, and carry timestamps of the times at which the contact A and contact B update the logs. In this way, the single contact data pulling module S221 may obtain the data from the contact data discretely storing module S224 according to the information carried in the update notification message.

The apparatus S22 may further includes a SNS relation chain storing module S226, configured to store contact information of contacts concerned by the user, provide a foundation for obtaining the feeds content data of the contacts by the single contact data pulling module S221, and send a contact information change message to the single contact data pulling module S221 when the contact information changes.

The single contact data pulling module S221 performs corresponding processing, such as deleting data or adding data, on the obtained feeds content data according to the contact information change message sent by the SNS relation chain storing module S226.

When the contact information is added to the message, obtained feeds content data corresponding to the contact information is sent to the contact data mixing and sorting processing module S222. When the message includes deleted contact information, the feeds content data corresponding to the contact information is deleted from the contact data aggregation module S223.

The SNS relation chain storing module S226 may specifically include: a contact information setting unit S226′, configured to set contact information, or to receive contact information set by the system. The process for setting the contact information mainly includes adding or deleting the contact information.

The system may also automatically identify the contacts of the user through the contact information of the user, and configure the contact information in the SNS relation chain, except for that the user chooses to add or delete the contact information. The configuration mainly includes: adding a piece of contact information to or deleting a piece of contact information from the contact information.

The SNS relation chain storing module S226 further includes a storing unit S226″, configured to store the contact information set by the contact information setting unit S226′, and store the contact information set by the system.

The SNS relation chain storing module S226 further includes a monitoring unit S226′″, configured to monitor the contact information stored by the storing unit S226″, and send a contact information change message to the single contact data pulling module S221 when the contact information changes. The message includes changed contact information.

The apparatus S22 may further include a timestamp recording module S227, configured to store the latest update time as a timestamp of this update every time the feeds content data of a contact is obtained.

The single contact data pulling module S221, according to information of a contact whose data is updated and the timestamp of the update time included in the update notification message sent by the contact data update notifying module S225, compare the stored timestamp with the timestamp of the update time, pull out the updated data corresponding to the timestamp of the update time if the timestamp of update time is closer to the current time than the stored timestamp, send the updated data to the contact data aggregation module S223, and store the timestamp which is closest to the current time of the timestamps of the update times, as a timestamp of this update.

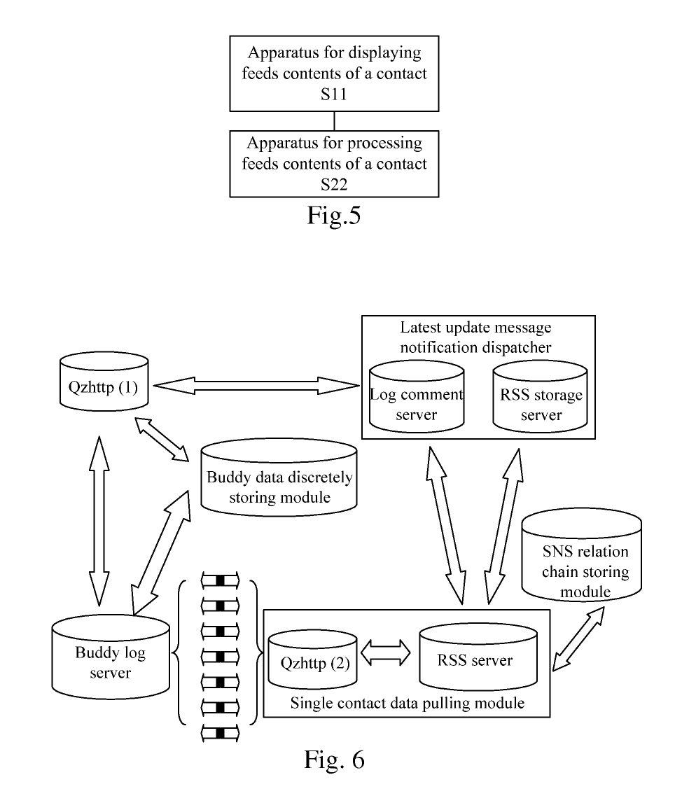

As shown in FIG. 5, a SNS relation chain based system for aggregating feeds contents of contacts includes an apparatus S11 for displaying feeds contents of contacts as shown in FIG. 3, configured to, when the user sends a request for obtaining feeds contents of a contact, pull complete information of the feeds contents corresponding to the request from the mixed and sorted data, and display the pulled out feeds contents.

The system further includes an apparatus S22 for processing feeds contents of contacts as shown in FIG. 4, configured to obtain feeds content data of the contacts of the user, mix and sort the obtained data, and aggregate the mixed and sorted data.

Various embodiments and accompanying drawings will be described further.

A first embodiment which uses a log module in a blog of a contact by way of example.

As shown in FIG. 6, Qzhttp(1), which is a Web server for directly providing services to the user, mainly provides the following services: pulling the abstract list of logs of a contact, pulling contents of a log of a buddy, answering the log of a buddy, and so on. The various embodiment implements the function of the apparatus S11 for displaying the feeds contents of the contacts with Qzhttp(1).

The requested feeds content data of the contact may be directly displayed through the apparatus S11 for displaying feeds contents of the contacts without accessing the site where the feeds content data changes.

Qzhttp(1) may specifically include a display content pulling unit S111, configured such that when a user sends a request for obtaining feeds contents of a contact, i.e., log contents of a contact in the present embodiment, and pull complete information of the feeds contents corresponding to the request from the mixed, sorted and aggregated feeds content data the contacts. The feeds content data of the embodiment may be mixed and sorted in accordance with the publication time of the logs, and display the mixed and sorted data in a log abstract list to the user. The user may obtain demanded log contents through selecting the contents in the log abstract list.

The Qzhttp(1) may further include a data displaying unit S112, configured to display the complete information of the feeds contents which correspond to the request and are pulled out by the display content pulling unit, and display the contents corresponding to the abstract selected by the user to the user in the present embodiment.

The apparatus S22 for processing the feeds contents of the contacts includes a single contact data pulling module S221, configured to obtain the feeds content data of a contact of a user. Functions of the module are achieved by encapsulating Qzhttp(2) and RSS server as shown in the figures of the present embodiment.

The apparatus S22 further includes a Qzhttp(2), which is a Web server for providing log services in the present embodiment, mainly pulls RSS data of a single user and information data of the other users in a log system, and processes feeds content data of contacts according to contact information stored in SNS relation chain, such as deleting or adding contact data.

The apparatus S22 further includes a RSS server, configured to compare a stored timestamp with a timestamp of updated data when Qzhttp(2) requests to pull data, pull corresponding data and send the pulled out data to the Qzhttp(2) if the timestamp of the updated data is closer to the current time than the stored timestamp; otherwise, pull the latest ten logs of the user requested by the Qzhttp(2) and return pulled out logs to the Qzhttp(2), and generate RSS data and store the generated RSS data.

The apparatus S22 further includes a contact data mixing and sorting processing module S222, configured to mix and sort the feeds content data obtained by the single contact data pulling module S221.

The apparatus S22 further includes a contact data aggregation module S223, configured to aggregate the mixed and sorted data processed by the contact data mixing and sorting processing module S222.

In the present embodiment, the contact data mixing and sorting processing module S222 and the contact data aggregation module S223 are encapsulated into a contact log storage server in the figures.

The contact log storage server is a storage platform for providing log abstracts and contents for all contacts of the user, and may mix and sort the feeds content data of the contacts according to publication time of the logs, aggregate the sorted data, and provide pulled out log abstract lists and corresponding contents to the Qzhttp(1).

The mixing and sorting operation includes: sorting the data according to the publication time of the data, or usernames of the users who publish the data, or categories of users who publish the data. For example, the mixing and sorting operation is performed according to the publication time of the logs, usernames, user categories, or interests of the users, and so on. In practice, the user may randomly choose a mixing and sorting mode.

The method of aggregation may include directly aggregating the mixed and sorted data, or aggregating the mixed and sorted data according to a certain law. For example, feeds content data of contacts who publish logs at a same time is aggregated together, or the feeds content data is aggregated together according to the user names of the contacts.

The mixing, sorting and aggregation is performed on the data pull out by the single contact data pulling module S221 with the contact data mixing and sorting processing module S222 and the contact data aggregation module S223. When the contact information is requested, information of the feeds contents is visually displayed to the user in various aggregation and sorting manners, which improves the users' experiences.

The apparatus S22 may further include a contact data discretely storing module S224, configured to store feeds content data of all contacts and timestamps corresponding to the feeds content data, and provide data sources when the single contact data pulling module S221 obtains feeds content data of all the contacts.

By storing the timestamps corresponding to the feeds contents in the contact data discretely storing module S224, the problem that the data will be repeatedly pulled out when the updated resources are obtained can be avoided. It is unnecessary to repeatedly pull out the data unless the system breaks or the contact information changes.

As shown in FIG. 6, the contact data discretely storing module S224 may be obtained by encapsulating the RSS storage server and the log comment server as shown in FIG. 6.

The RSS storage server, which is a storage server for providing the RSS data, is configured to store feeds content data of all contacts in the system, and updated feeds content data of the contacts and corresponding timestamps, e.g., may store a certain number of logs which are latest updated by a contact. In a preferable embodiment, the number may be 10.

The log comment server, which is a storage server for providing log texts and answers, is configured to provide log reading and writing services. When complete contents of requested logs are displayed on the user terminal, some comments may be made on the logs.

The apparatus S22 may further include a contact data update notifying module S225, configured to monitor feeds content data of all contacts every time the feeds content data of a contact is obtained, and send an update notification message to the single contact data pulling module S221 when the feeds content data is updated.

The single contact data pulling module S221 updates the obtained feeds content data according to the update notification message sent by the content data update notifying module S225.

As shown in FIG. 6, the contact data update notifying module S225 may adopt a latest update message notification dispatcher which may be called a message dispatching server, to provide a latest update message dispatching service. In this embodiment, the message dispatching server is configured to send a buddy log storage server a log update notification message, such as a notification message indicating adding a log or deleting a log.

For instance, it is supposed that logs of some contacts among all contacts of the user are updated, and then the message dispatching server may carry information of contacts whose log are updated and the timestamps of the times at which the logs are updated in a log update notification message. In this way, the single contact data pulling module S221 may accurately obtain data from the contact data discretely storing module S224 according to information carried in the log update notification message.

As shown in FIG. 6, the apparatus S22 may further include a SNS relation chain storing module S226, configured to store information of contacts of the user, provide the information for obtaining feeds content data of contacts to the single contact data pulling module, and send a contact information change message to the single contact data pulling module when the information of the contacts is changed.

The single contact data pulling module performs corresponding processing, such as deleting data or adding data, on obtained feeds content data according to the contact information change message sent by the SNS relation chain storing module.

When the contact information is added to the message, obtained feeds content data corresponding to the contact information is sent to the contact data mixing and sorting processing module. When the message includes deleted contact information, feeds content data corresponding to the contact information is deleted from the contact data aggregation module.

The SNS relation chain storing module S226 may specifically include a contact information setting unit S226′, configured to set contact information, or receive contact information set by the system.

Except for that the user itself may choose to add or delete the contact information, the system may also automatically identify the contact information of the user, and add or delete contacts for the user. For example, each contact of the user has at least one contact, so the system may identify contacts of the contact as contacts of the user, and add the contacts to the contact information in the SNS relation chain.

The SNS relation chain storing module S226 further includes a storing unit S226″, configured to store the contact information set by the contact information setting unit S226′, and store the contact information set by the system.

The SNS relation chain storing module S226 further includes a monitoring unit S226′″, configured to monitor the contact information stored by the storing unit S226″, and send a contact information change message to the single contact data pulling module S221 when the contact information is changed. The message includes changed contact information.

Relevant information of added contacts, such as usernames or IP addresses, is carried in the message, to obtain feeds content data corresponding to the added contacts.

The apparatus S22 may further include a timestamp recording module (which is not shown in FIG. 6 and may be encapsulated in the buddy log storage server), configured to, every time the feeds content data (such as the log data in the embodiment of the present invention) of a contact is obtained, store the update time which is closest to the current time, among the update time of the data, as a timestamp of this update. The single contact data pulling module S221, according to information of a contact whose data is updated and timestamp of update time included in the update notification message sent by the contact data update notifying module S225, compares the timestamp stored by the timestamp recording module with the timestamp of update time, if the timestamp of update time is closer to the current time than the stored timestamp, pulls out the updated data corresponding to the timestamp of the update time, sends the updated data to the contact data aggregation module S223, and stores the timestamp which is closest to the current time, among the timestamps of the update times, as the timestamp of this update.

Feeds content data of the contacts obtained by the user may include data in a time period. In order to avoid repeatedly obtaining overdue data next time the data is obtained, the latest update time is stored as the timestamp of this update, which may be taken as a reference timestamp for obtaining the latest dynamic data next time.

The received contact data update notification message may carry a username or an IP address of a contact whose data is updated, and the timestamp of the update time. Thus, when obtaining the latest data of a contact, a stored timestamp may be compared with the timestamp of the update time at which the contact latest updates the data. If the timestamp of the update time is closer to the current time than the stored timestamp, the all updated data corresponding to the timestamp of the update time at which the contact latest updates the data is pulled out.

The application process of the various embodiments is implemented as follows:

When the feeds content data of all the contacts is obtained, the obtained data is mixed, sorted and aggregated, and the aggregated data is stored. The publication time which is closest to the current time, among the publication time of the mixed, sorted and aggregated log data is selected and stored as a timestamp of this update. When the feeds content data of the contacts is not updated, the mixed and sorted data which is stored is directly sent to the user who sends a request. When the feeds content data of the contacts is updated, the data obtained by the latest update is obtained from the feeds content data of the contacts, and the data obtained by the latest update is directly added to the mixed and sorted data which is stored. Thus, the time for mixing, sorting and aggregating the feeds content data of all contacts may be saved.

Unless the contact information in the SNS relation chain is changed, it needs not to add or delete the corresponding contact data and perform the mixing and sorting processing.

In practical application, various embodiments may obtain the feeds content data of the contacts through another manner. The specific processes are as follows.

The mixed and sorted data is aggregated and then directly sent to the user who sends a request without being stored. When the feeds content data of all contacts of the user is updated, the data obtained by the latest update of the contacts (the contacts of the user only store the feeds content data obtained by the latest update as their own data) is obtained according to the update notification message, and the data obtained by the latest update is mixed, sorted and aggregated, and then is sent to the user who sends a request. In this way, every time the contact data of the user is updated, the mixing and sorting processing will be performed, but the storage can be saved.

When the above two technical solutions are applied, it is necessary to process the previously obtained feeds content data of the contacts again according to the changed contact information when the SNS relation chain is changed. If contact information is added, feeds content data of relevant contacts should be added to the data. If contact information is deleted, corresponding information should be deleted from the obtained feeds content data. For the case that contact information is added, the feeds content data of added contacts should be re-mixed and sorted and aggregated again, to form new aggregated mixed and sorted data.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying feeds contents of a contact, comprising:
obtaining feeds content data of a contact of a user, mixing and sorting the feeds content data which comprises complete information of feeds contents; and
pulling out, when the user requests for obtaining the feeds contents of the contact, complete information of the feeds contents requested by the user, and displaying the complete information.

2. The method according to claim 1, wherein mixing and sorting the feeds content data comprises:
sorting the feeds content data according to publication time of the feeds content data, or usernames of users who publish the feeds content data, or categories of users who publish the feeds content data.

3. The method according to claim 1, wherein obtaining the feeds content data of the contact of the user comprises:
obtaining the feeds content data of the contact according to contact information set in a Social Networking Service (SNS) relation chain set by the user; or
obtaining the feeds content data of the contact according to a received update notification message when the feeds content data of the contact of the user is updated, the update notification message comprises information of contacts whose feeds content data is updated and timestamps of update times.

4. The method according to claim 3, further comprising:
obtaining feeds content data corresponding to added contact information when the contact information is added; and
deleting feeds content data corresponding to deleted contact information from the feeds content data when the contact information is cancelled.

5. The method according to claim 3, wherein obtaining the feeds content data of the contact according to the received update notification message comprises:
storing update time which is closest to the current time, in update time of the feeds content data as a timestamp of this update each time the feeds content data of the contact is obtained;
comparing the stored timestamp with the timestamps of the update times when the update notification message is received;
pulling out the feeds content data corresponding to the timestamp of an update time if the timestamp of the update time is closer to the current time than the stored timestamp, and
storing a timestamp which is closest to the current time in the timestamps of the update times as a timestamp of this update.

6. The method according to claim 1, further comprising:
aggregating mixed and sorted data, and storing aggregated mixed and sorted data;
obtaining feeds content data which is updated latest when the feeds content data of the contacts of the user is updated, and
adding the obtained dynamic data which is updated latest into the aggregated mixed and sorted data.

7. An apparatus for displaying feeds contents of contacts, comprising:
a display content pulling unit, the pulling unit pulling complete information of feeds contents corresponding to a request and obtaining the feeds contents of a contact sent by a user from feeds content data obtained by being mixed and sorted of the contact; and
a data displaying unit, the displaying unit displaying the complete information of the feeds contents corresponding to the request of the user and pulled out by the display content pulling unit.

8. The apparatus according to claim 7, the feeds content data comprises abstracts of the feeds contents of the contact of the user and the complete information of the feeds contents corresponding to the abstracts.

9. An apparatus for processing feeds contents of a contact, comprising:
a single contact data pulling module, the pulling module obtaining feeds content data of a contact of a user;
a contact data mixing and sorting processing module, the mixing module mixing and sorting the feeds content data obtained by the single contact data pulling module; and
a contact data aggregation module, the aggregation module aggregating the feeds content data obtained by being mixed and sorted by the contact data mixing and sorting processing module.

10. The apparatus according to claim 9, wherein the contact data mixing and sorting processing module is configured to sort the feeds content data according to publication time of the feeds content data, or usernames of users who publish the feeds content data, or categories of users who publish the feeds content data.

11. The apparatus according to claim 9, further comprises:
a contact data discretely storing module, the storing module storing feeds content data of all contacts and timestamps corresponding to the feeds content data of all the contacts and providing a data source when the single contact data pulling module obtains the feeds content data of the contact.

12. The apparatus according to claim 9, further comprising:
a contact data update notifying module, the notifying module monitoring feeds content data of all contacts every time feeds content data of a contact is obtained and sending an update notification message to the single contact data pulling module when the feeds content data is updated; wherein
the single contact data pulling module updates obtained feeds content data according to the update notification message sent by the content data update notifying module.

13. The apparatus according to claim 9, further comprising:
a SNS relation chain storing module, the storing module storing contact information of the user, providing a foundation for obtaining the feeds content data of the contact for the single contact data pulling module, and sending a contact information change message to the single contact data pulling module when the information of the contact is changed; wherein
the single contact data pulling module performs corresponding processing on obtained feeds content data according to the contact information change message sent by the SNS relation chain storing module; sends obtained feeds content data corresponding to the contact information to the contact data mixing and sorting processing module when the contact information is added in the message, and delete feeds content data corresponding to deleted contact information from the contact data mixing and sorting processing module when the message includes cancelled contact information.

14. The apparatus according to claim 13, wherein the SNS relation chain storing module comprises:
a contact information setting unit, the setting unit setting the contact information, or to receive the contact information set by the system;
a storing unit, the storing unit storing the contact information set by the contact information setting unit and storing the contact information set by the system; and
a monitoring unit, the monitoring unit monitoring the contact information stored by the storing unit and sending the contact information change message to the single contact data pulling module when the contact information is changed, the contact information change message comprises changed contact information.

15. The apparatus according to claim 12, further comprising:
a timestamp recording module, the recording module storing update time which is closest to the current time, in update time of the data, as a timestamp of this update every time feeds content data of a contact is obtained; wherein
the single contact data pulling module, according to contact information of a contact whose data is updated and timestamps of update times comprised in the update notification message sent by the contact data update notifying module, comparing the timestamp stored by the timestamp recording module with the timestamps of the update times, pulling out the updated data corresponding to the timestamp of an update time if the timestamp of update time is closer to current time than the timestamp stored by the timestamp recording module, sending the updated data to the contact data aggregation module, and stores a timestamp which is closest to current time, in the timestamps of update times, as a timestamp of this update.

16. A system for processing feeds contents of a contact, comprising:
an apparatus for displaying feeds contents of a contact pulling complete information of feeds contents corresponding to a request sent by a user for obtaining the feeds contents of a contact from mixed and sorted data and displaying the complete information; and
an apparatus for processing feeds contents of a contact, the feeds apparatus obtaining feeds content data of a contact of a user, mix and sort the feeds content data, and aggregate the mixed and sorted data.
